(19) United States
(12) Patent Application Publication
(10) Pub. No.: US 2026/0116472 A1
(43) Pub. Date: Apr. 30, 2026

(54) ROOF MODULE WITH COOLING SYSTEM

(71) Applicant: Webasto SE, Stockdorf (DE)

(72) Inventor: Thomas PODOLSKI, Stockdorf (DE)

(21) Appl. No.: 19/363,176

(22) Filed: Oct. 20, 2025

(30) Foreign Application Priority Data
Oct. 28, 2024 (DE) 10 2024 131 397.8

(51) Int. Cl. B62D 25/07; B60H 1/00; G03B 17/55

(52) U.S. Cl. CPC B62D 25/07; B60H 1/00271; B60H 2001/003; G03B 17/55

(57) ABSTRACT

Roof module for forming a vehicle roof on a motor vehicle, the roof module having a surface component which at least in some regions forms a roof skin of the vehicle roof, a tray which defines a wet area, an environment sensor for detecting a vehicle environment, wherein the environment sensor is arranged in a sensor housing which defines a dry area, wherein the environment sensor is arranged in the wet area in a retractable and extendable manner relative to the surface component and the tray, wherein the roof module also has a cooling device with a cooling line for cooling the sensor housing by an interior air of the motor vehicle, wherein the cooling line can be guided at least in some regions through the wet area into an interior and/or a vehicle frame of the motor vehicle.

### CROSS-REFERENCE TO RELATED APPLICATION(S)

This application claims the benefit of German Application No. 10 2024 131 397.8 filed Oct. 28, 2024, which is incorporated herein by reference in its entirety.

### TECHNICAL FIELD

This disclosure relates generally to a roof module for forming a vehicle roof on a motor vehicle, with a cooling device.

### BACKGROUND

Roof modules are extensively used in vehicle production. For example, roof modules are pre-fabricated as separate functional modules and connected on the assembly line to a roof frame structure (which is a part of the body structure). The roof module at least in some regions forms a roof skin of the vehicle roof which prevents a penetration of moisture or an air flow into the vehicle interior. The roof skin is formed by one or more surface components which can be produced from a stable material, for example painted sheet metal or painted or solid-colored plastics. The roof module can be a part of a rigid vehicle roof or a part of an openable roof subassembly.

Moreover, developments in vehicle production are increasingly targeted at autonomously or semi-autonomously driving motor vehicles. In order to permit the vehicle controller to control the motor vehicle autonomously or semi-autonomously, a plurality of environment sensors are used (for example lidar sensors, radar sensors, (multi) cameras, etc. together with further (electrical) components) which are integrated, for example, in the roof module, which detect the environment all around the motor vehicle and, for example, determine a respective traffic situation from the detected environmental data. Roof modules which are provided with a plurality of environment sensors are also known as a roof sensor module (RSM). The known environment sensors transmit or receive corresponding electromagnetic signals, for example laser beams or radar beams, whereby a data model of the vehicle surroundings can be generated by a corresponding signal evaluation and can be used for the vehicle control. The environment sensors can be arranged, for example, on the vehicle roof in a retractable or extendable manner or even rigidly or immovably.

As far as possible an uninterrupted or continuous availability of the environment sensors and the further (electrical) components is required for a reliable mode of operation, safety and availability of the autonomous or semi-autonomous driving mode. To this end, it should be avoided, amongst other things, that the environment sensors overheat during operation.

To avoid overheating, the use of cooling devices is known, at least conceptually. However, in known technical applications difficulties continue to be present in the field of water management, in particular when it is a case of diverting penetrating water from the environment out of the cooling device again, without damaging further components of the cooling device, for example fans, etc.

### SUMMARY

It is an object of the present invention to provide an improved roof module.

This object is achieved by a roof module according to the teaching of claim 1.

Advantageous embodiments of the invention form the subject matter of the dependent claims.

Advantageous embodiments of the invention form the subject matter of the dependent claims. All of the combinations of at least two features disclosed in the description, the claims and/or the figures fall within the scope of the invention. It goes without saying that the statements made relative to the roof module refer in an equivalent manner to the vehicle without this being mentioned again in a redundant manner. In particular, it goes without saying that customary linguistic changes and/or an expedient replacement of respective terms in the context of normal linguistic practice, in particular the use of synonyms supported by the generally recognized linguistic literature, are encompassed by the present disclosure without being explicitly mentioned in their respective formulation.

In a first aspect, a roof module is proposed for forming a vehicle roof on a motor vehicle. The roof module has a surface component which at least in some regions forms a roof skin of the vehicle roof. The roof module has a tray which defines a wet area. The roof module has an environment sensor for detecting a vehicle environment, wherein the environment sensor is arranged in a sensor housing which defines a dry area, wherein the environment sensor is also arranged in the wet area in a retractable and extendable manner relative to the surface component and the tray. The roof module also has a cooling device with a cooling line for cooling the sensor housing by means of interior air of the motor vehicle, wherein the cooling line can be guided at least in some regions through the wet area into an interior and/or a vehicle frame of the motor vehicle.

In terms of its intended use, the roof module is preferably configured to be arranged on a motor vehicle or a body of the motor vehicle.

The tray preferably forms a self-contained frame. The tray can be, for example, part of a roof module frame of the roof module. The tray can have, for example, a drain at a lowest point in order to drain water out of the tray. The components which are arranged in the tray are not protected against moisture and can come into contact with the water which can run into the tray.

The water flowing in from outside can be, for example, rain water or even water which is used when cleaning the vehicle.

The dry area is preferably free from water or moisture. The sensor housing is preferably self-contained and accommodates the environment sensor and optionally further components. In other words, in order to permit a cooling via the interior of the vehicle, the environment sensor is located in a dry space or the dry area. In the retractable and extendable version of the environment sensor, this dry “sensor space” is preferably movable.

At least one of the preferably two cooling lines can preferably be connected to the interior of the vehicle or guided to the interior. This cooling line preferably provides a cooling air supply from the interior of the vehicle to the sensor housing. The other of the preferably two cooling lines can preferably be attached to a vehicle frame. This cooling line preferably provides a cooling air discharge from the sensor housing into the vehicle frame and thus out of the vehicle. Alternatively, the cooling air discharge can also be returned into the interior of the vehicle.

It goes without saying that at least one of the preferably two cooling lines or the cooling device can have an air filter and/or a cooler and/or another cooling component, for example a cooling element, or the like.

The roof module has the advantages that, on the one hand, an expensive and complex water management geometry can be dispensed with, as is often required in cooling devices which require an external air supply, in order to prevent, for example, the penetration of rain water into the interior of the cooling device. As a result, installation space can be saved. In the present case, therefore, a functioning compact cooling concept which can be directly integrated in existing roof module systems is proposed. The present roof module provides a small compact solution with comparable cooling performance as can be achieved with an integration of an environment sensor directly in the interior of the vehicle, for example behind the windshield. Moreover, in the present case it is possible to conduct exhaust cooling air directly into the vehicle frame, which makes the drainage structurally simple.

In a further aspect, it is proposed that the cooling line is configured as a flexibly movable hose which is fluidically connected to the interior and/or the vehicle frame of the vehicle and the sensor housing.

In a further aspect, it is proposed that the cooling device has two or more cooling lines.

In a further aspect, it is proposed that the two cooling lines are configured as flexibly movable hoses which are fluidically connected in each case to the interior and/or the vehicle frame of the vehicle and the sensor housing.

The dry area is preferably connected to the interior of the vehicle via flexible hoses which lead through the wet space. The interior of the vehicle is located outside the tray or the wet area.

In a further aspect, it is proposed that the tray is configured, at least in an extended state of the environment sensor, to collect water flowing in from outside between the surface component and the sensor housing and to divert it out of the roof module.

For example, water which flows in and which preferably flows past a peripheral seal, which is arranged between the sensor housing and the surface component or the roof skin, is collected by the tray which forms a closed frame and is diverted in a targeted manner via a drain or one or more hoses out of the roof module or the vehicle. The seal between the tray and the roof skin preferably prevents an overflow of the water into the interior, for example when the drain functions to a limited extent.

In a further aspect, it is proposed that, at least in the retracted state of the environment sensor, the sensor housing is arranged with the environment sensor in the tray which defines the wet area.

The sensor housing is preferably designed such that it can be received by the tray when the environment sensor is in the retracted position.

In a further aspect, it is proposed that the cooling device has a fan which is preferably arranged in the sensor housing or in one of the preferably two cooling lines.

The fan can preferably be integrated in the sensor housing. Alternatively, the fan can be directly arranged on the environment sensor. Alternatively, the fan can be placed separately in the dry area or outside, for example in the region of a cooling air inlet or a cooling air outlet. The correct choice of flow direction has to be considered according to the arrangement.

In a further aspect, it is proposed that the at least one cooling line can be guided out of the wet area into the interior via an interface provided in the tray, wherein the at least one cooling line is connected in a moisture-tight manner to the interface of the tray or is guided through the interface of the tray.

The interface can have, for example, a hose connection. Alternatively, the interface can also have openings through which the cooling lines can be guided in each case. The openings are preferably sealable relative to the cooling lines, so that no water can pass via the interface into the interior of the vehicle. Other interfaces are also conceivable.

In a further aspect, it is proposed that at least one of the preferably two cooling lines is designed to receive an electrical connection and/or a cleaning port of the environment sensor.

Moreover, the preferably two cooling lines can thus be used for passing through electrical cables or cleaning hoses of a cleaning system of the environment sensor. This saves additional installation space. Moreover, in this manner it is possible to make use of synergies in the sealing, since the electrical cables or cleaning hoses no longer have to be separately guided through the tray and the wet area to the environment sensor.

In a further aspect, it is proposed that the environment sensor has a lidar sensor and/or a radar sensor and/or a camera sensor and/or a multi-camera sensor and/or an ultrasound sensor.

Further types of sensor are also conceivable, so that the list is not to be understood as exhaustive.

In a further aspect, it is proposed that the roof module can be assembled as a pre-assembled structural unit on a motor vehicle.

The roof module can preferably be fully pre-assembled, so that it only has to be arranged on the motor vehicle. In the present case, the preferably two cooling lines are then also connected to the interior and/or the vehicle frame.

The roof module can be arranged in principle at any point of a motor vehicle and designed for different purposes.

It goes without saying that the embodiments and exemplary embodiments mentioned above and to be explained in more detail below can be configured not only individually but also in any combination with one another, without departing from the scope of the present invention. It also goes without saying that the embodiments and exemplary embodiments mentioned above and to be explained in more detail below refer to all of the embodiments of the invention in an equivalent or at least similar manner, without being separately mentioned in each case.

### BRIEF DESCRIPTION OF DRAWINGS

Embodiments of the invention are shown schematically in the drawings and are explained by way of example below.

FIG. 1 shows a schematic view of a roof module in an embodiment.

FIG. 2 shows a schematic view of a sensor module of the roof module in an embodiment.

FIG. 3 shows the sensor module in an embodiment.

FIG. 4 shows a sensor module in an embodiment.

FIG. 5 shows a sensor module in an embodiment.

FIG. 6 shows a sensor module in an embodiment.

FIG. 7 shows a sensor module in an embodiment in a sectional view.

FIG. 8 shows a sensor module in an embodiment in a plan view.

### DETAILED DESCRIPTION

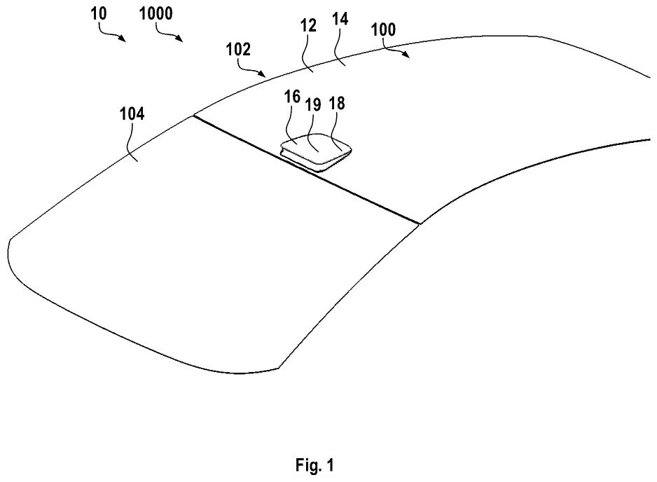

A vehicle roof 100 of a motor vehicle 1000 which comprises a roof module 10 is shown in FIG. 1. The roof module 10 is arranged as a separate pre-assembled structural unit on a roof body frame 102 of the motor vehicle 1000.

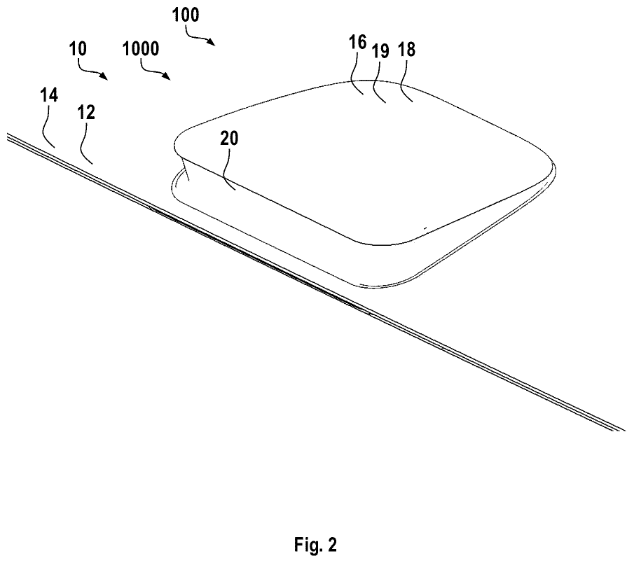

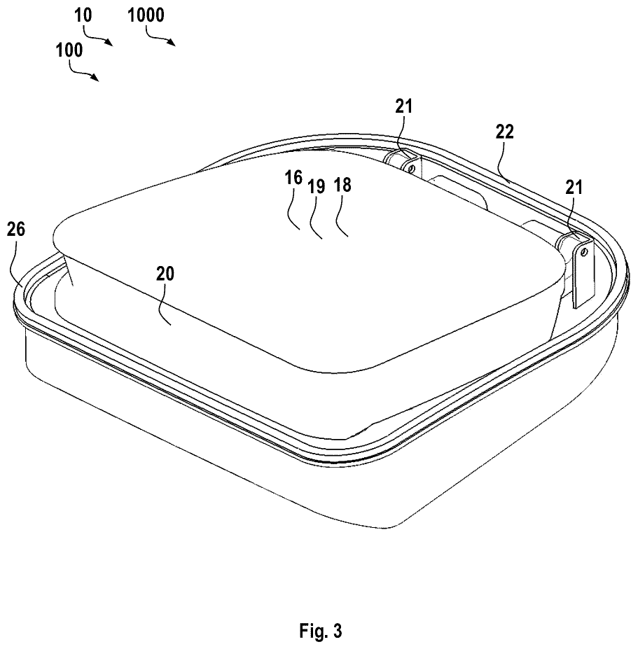

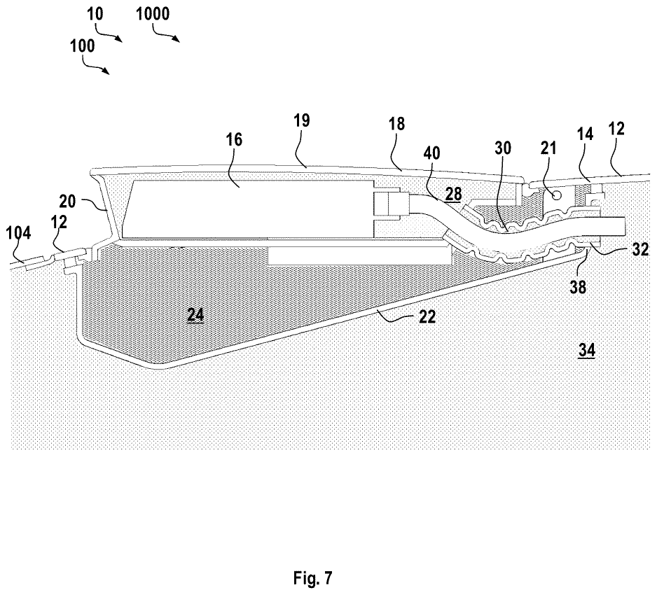

The roof module 10 comprises a surface component 12 for forming a roof skin 14 of the vehicle roof 100 which functions as an outer sealing surface. Moreover, the roof module 10 comprises an environment sensor 16 for detecting a vehicle environment. The environment sensor 16 is arranged in a sensor housing 18 and is retractable and extendable relative to the surface component 12. The sensor housing 18 can also have, for example, a cover 19 which in the retracted state of the environment sensor 16 terminates flush with the surface component 12. The retraction and extension of the environment sensor 16 takes place via any kinematic mechanism 21, for example an articulated kinematic mechanism, in which the environment sensor 16 can be rotated about an axis of rotation. In the present case, the environment sensor 16 is arranged in a front region of the vehicle roof 100 in the region of a front wind deflector directly adjacent to a windshield 104. The environment sensor 16 detects the vehicle environment through a see-through area 20, see FIGS. 2, 3 and 7.

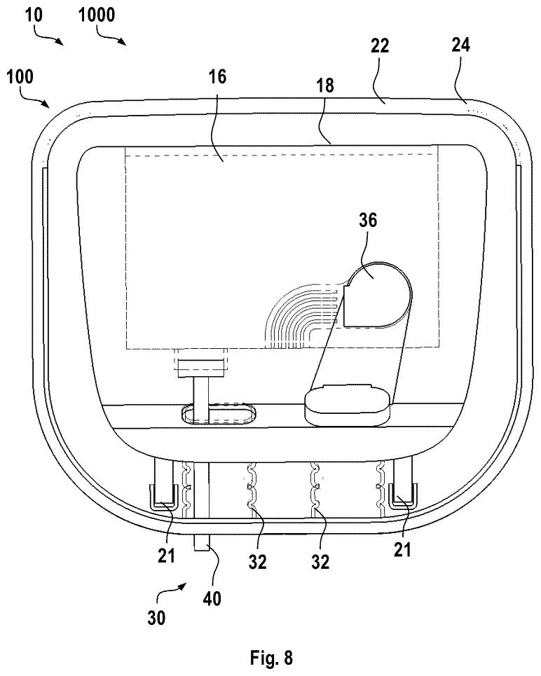

The roof module also comprises a tray 22. The tray 22 defines a wet area 24 which is sealed relative to a vehicle interior. The tray 22 is configured to receive the sensor housing 18 when the environment sensor is in the retracted position. The tray 22 can be arranged, for example, on the surface component 12 or on a roof module frame (see FIG. 8). The tray 22 can be, for example, adhesively bonded to the surface component 12 or connected thereto by means of a screw connection, wherein a seal is created between the tray and the surface component, preferably by means of a sealing profile. A seal 26 can be provided between the surface component 12 and the sensor housing 18, for example, in an edge region of the tray 22 or on the surface component 12. The sensor housing 18 forms a dry area 28 (see FIG. 8). The tray 22 is configured at least in an extended state of the environment sensor 16 to collect water flowing in from outside between the surface component 12 and the sensor housing 18 and divert it out of the roof module 10 (not shown).

The roof module 10 further comprises a cooling device 30. The cooling device 30 has, for example, two cooling lines 32 for cooling the sensor housing 18 or the environment sensor 16 by means of an interior air of the motor vehicle 1000. The two cooling lines 32 are guided at least in some regions through the wet area 24 into an interior 34 (see FIG. 8) of the motor vehicle 1000. The two cooling lines 32 are configured as flexibly movable hoses which in each case are fluidically connected to the interior 34 and/or a vehicle frame (not shown) of the motor vehicle 1000 and the sensor housing 18.

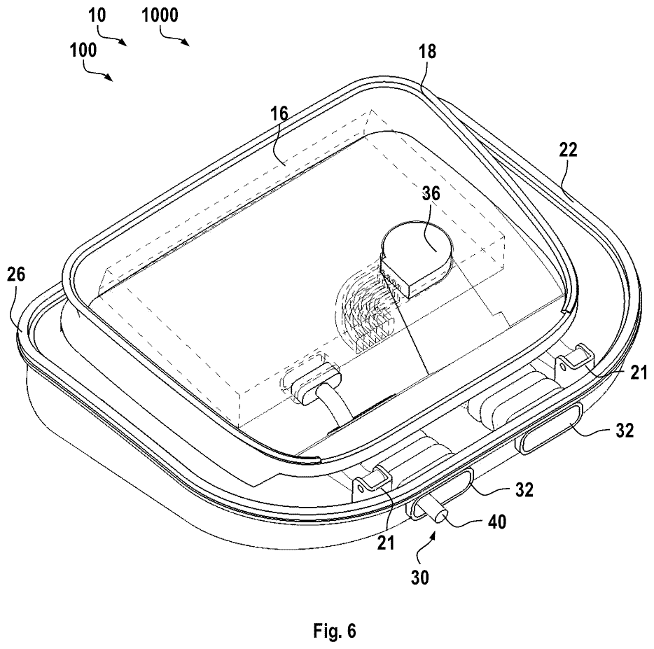

The cooling device 30 also has a fan 36 which in the present case can be arranged in the sensor housing 18 or in one of the two cooling lines 32 (see FIGS. 6 and 8).

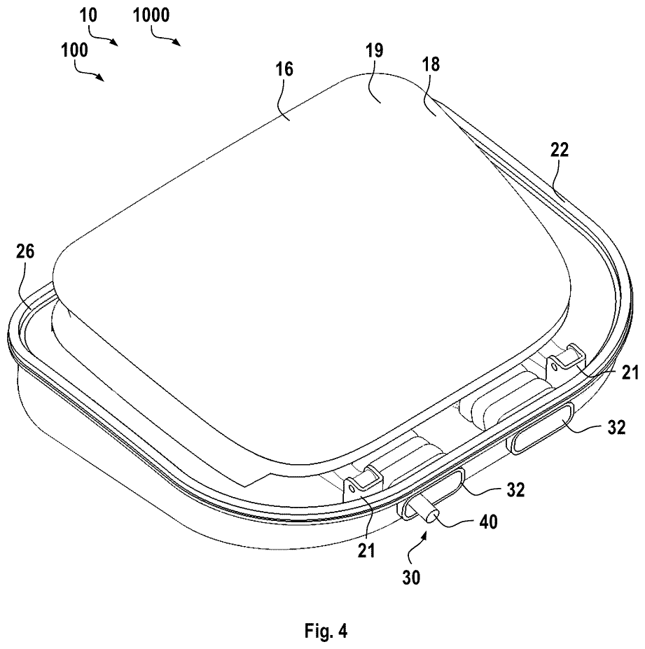

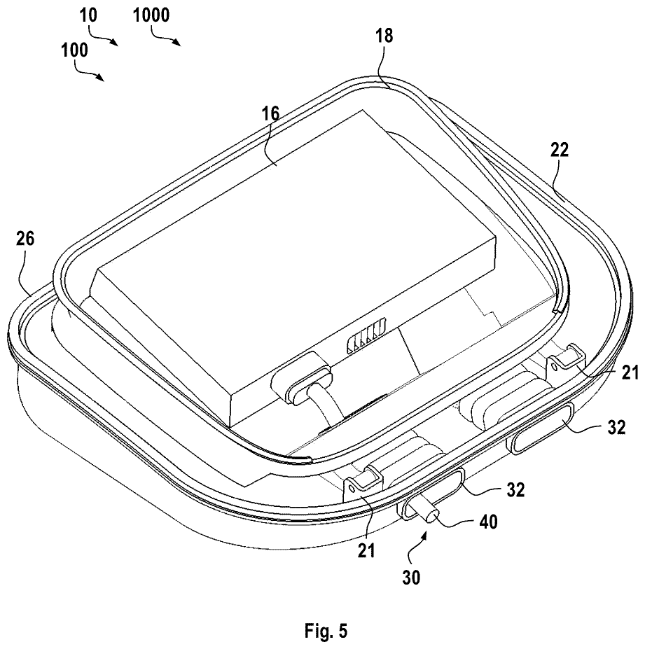

The two cooling lines 32 are guided out of the wet area 24 into the interior 34 via an interface 38 provided in the tray 22. The interface 38 is sealed between the tray 22 and the two cooling lines 32. The two cooling lines 32 are thus connected in each case in a moisture-tight manner to the interface 38 of the tray 22 or guided through the interface 38 of the tray 22. At least one of the two cooling lines 32 is also designed to receive an electrical connection or a cable 40 and/or a cleaning port of the environment sensor 16 (see FIGS. 4 to 8).

### List of Reference Signs

10 Roof module
12 Surface component
14 Roof skin
16 Environment sensor
18 Sensor housing
19 Cover
20 See-through area
21 Kinematic mechanism
22 Tray
24 Wet area
26 Seal
28 Dry area
30 Cooling device
32 Cooling lines
34 Interior
36 Fan
38 Interface
40 Connector
100 Vehicle roof
102 Roof body frame
104 Windshield
1000 Motor vehicle

1. A roof module for forming a vehicle roof on a motor vehicle, the roof module having:
a surface component which at least in some regions forms a roof skin of the vehicle roof,
a tray which defines a wet area,
an environment sensor for detecting a vehicle environment,
wherein the environment sensor is arranged in a sensor housing which defines a dry area,
wherein the environment sensor is arranged in the wet area in a retractable and extendable manner relative to the surface component and the tray,
wherein the roof module also has a cooling device with a cooling line for cooling the sensor housing by means of an interior air of the motor vehicle, and
wherein the cooling line is guided at least in some regions through the wet area into an interior and/or a vehicle frame of the motor vehicle.

2. The roof module as claimed in claim 1, wherein the cooling line is configured as a flexibly movable hose which is fluidically connected to the interior and/or the vehicle frame of the vehicle and the sensor housing.

3. The roof module as claimed in claim 1, wherein the tray is configured, at least in an extended state of the environment sensor, to collect water flowing in from outside between the surface component and the sensor housing and to divert it out of the roof module.

4. The roof module as claimed in claim 1, wherein, at least in the retracted state of the environment sensor, the sensor housing is arranged with the environment sensor in the tray which defines the wet area.

5. The roof module as claimed in claim 1, wherein the cooling device has a fan which is arranged in the sensor housing or in the cooling line.

6. The roof module as claimed in claim 1, wherein the cooling line is guided out of the wet area into the interior via an interface provided in the tray, wherein the cooling line is connected in a moisture-tight manner to the interface of the tray or is guided through the interface of the tray.

7. The roof module as claimed in claim 1, wherein the cooling line is designed to receive an electrical connection and/or a cleaning port of the environment sensor.

8. The roof module as claimed in claim 1, wherein the environment sensor has a lidar sensor and/or a radar sensor and/or a camera sensor and/or a multi-camera sensor and/or an ultrasound sensor.

9. The roof module as claimed in claim 1, wherein the roof module is assembled as a pre-assembled structural unit on a motor vehicle.

10. A motor vehicle comprising a roof module as claimed in claim 1.
